(19) United States
(12) Patent Application Publication
(10) Pub. No.: US 2026/0175663 A1
(43) Pub. Date: Jun. 25, 2026

(54) GLASS RUN

(71) Applicant: TOYODA GOSEI CO., LTD., Kiyosu-shi (JP)

(72) Inventors: Masatoshi Nojiri, Kiyosu-shi (JP); Tasuku Ishiguro, Kiyosu-shi (JP)

(21) Appl. No.: 19/413,139

(22) Filed: Dec. 9, 2025

(30) Foreign Application Priority Data
Dec. 19, 2024 (JP) 2024-224007

(51) Int. Cl. B60J 10/76; B60J 10/50

(52) U.S. Cl. CPC B60J 10/76; B60J 10/50

(57) ABSTRACT

A glass run includes a bottom wall, a vehicle outer side wall, and a vehicle inner side wall being attached to a door frame groove portion formed in a door frame and guiding raising and lowering of a door glass, in which a hard portion having a higher hardness than the vehicle outer side wall is formed on the vehicle inner side of the vehicle outer side wall while being in sliding contact with the door glass, the vehicle outer side wall is in surface contact with the door frame groove portion, a vehicle outer groove portion and a vehicle inner groove portion are formed on door glass sides of connecting portions between the bottom wall and the vehicle outer side wall and between the bottom wall and the vehicle inner side wall, respectively, and the vehicle inner groove portion has a greater thickness than the vehicle outer groove portion.

### CROSS REFERENCE TO RELATED APPLICATION

This application claims the priority benefit of Japanese Patent Application No. 2024-224007 filed on Dec. 19, 2024. The entirely of the above-mentioned patent application is hereby incorporated by reference herein and made a part of this application.

### BACKGROUND OF THE INVENTION

### (1) Field of the Invention

The present invention relates to a glass run attached to a door frame formed on a door of a vehicle such as an automobile.

### (2) Description of Related Art

Improving quietness of vehicles such as automobiles enhances the comfort of occupants and therefore serves as a strong appeal point for improving product value. Further, in electric vehicles, which are expected to become rapidly widespread in the future, since the conventional engine that is mounted is eliminated, the engine noise is also lost, and as a result, the main remaining noises that become prominent are road noise and wind noise. Therefore, the necessity for these noise-reduction techniques has become greater than ever before.

For example, in FIG. 7, a technique of reducing vibration by using impedance matching that brings the impedance of a glass run close to the impedance of glass by increasing the rigidity of the glass run (for example, Japanese Patent Application Laid-Open No. 2023-53894) is illustrated.

In FIG. 7, a glass run 100 includes a bottom wall 200, a vehicle outer side wall 300, and a vehicle inner side wall 400 as its basic structure. The basic structure is attached to a door frame groove portion 500 formed in a door frame 310 and guides raising and lowering of a door glass 600. On the vehicle inner side of the vehicle outer side wall 300, a thick portion 330 having a hardness higher than that of the vehicle outer side wall main body portion 320 of the vehicle outer side wall 300 is formed to protrude toward the vehicle inner side and come into sliding contact with the door glass 600.

Further, on a vehicle outer side of the vehicle outer side wall 300, a first vehicle outer holding lip 340 and a second vehicle outer holding lip 350, which are engaged with a door frame groove portion 500, are formed opposite to each other from a region in a vicinity of a connecting portion with the bottom wall 200 toward a direction of a tip end portion of the vehicle outer side wall 300, and the door frame groove portion 500, which is formed in a bent shape, is held by the first vehicle outer holding lip 340 and the second vehicle outer holding lip 350.

### SUMMARY OF THE INVENTION

Further, by bringing the vehicle outer side wall 300, on which the thick portion 330 having high hardness is formed, into contact with the door frame groove portion 500 to form a structure in which the door glass 600 and the door frame groove portion 500 sandwich the vehicle outer side wall 300 including the thick portion 330, it is possible to increase the rigidity of the vehicle outer side wall 300 with respect to the door glass 600 and the door frame groove portion 500 and further reduce vibration through impedance matching.

However, in a vehicle such as an automobile, the door frame 310 and the door frame groove portion 500 formed inside the door frame are curved in the vertical direction and the longitudinal direction of the vehicle. Since the thick portion 330 having high hardness is formed on the vehicle outer side wall 300 when the substantially straight glass run 100 is attached, the followability of the door frame groove portion 500 to bending decreases compared with the vehicle inner side wall 400, and a region in which the vehicle outer side surface of the vehicle outer side wall 300 does not come into contact with the door frame groove portion 500 is generated.

Furthermore, since the curvature of the door frame 310 (door frame groove portion 500) and the curvature of the door glass 600 do not match each other, variations in contact pressure with the door frame groove portion 500 due to the vehicle outer side wall 300 including the thick portion 330 occur at the time of sliding contact with the door glass 600, and the effect of reducing vibration using impedance matching is not sufficiently exhibited.

In order to solve the above problems, a first aspect of the present invention is a glass run having a bottom wall, a vehicle outer side wall, and a vehicle inner side wall as a basic structure, the basic structure being attached to a door frame and guiding raising and lowering of a door glass, in which, in the vehicle outer side wall, a hard portion having a hardness higher than that of the vehicle outer side wall is formed inside the vehicle outer side wall or exposed on a vehicle inner side thereof, a vehicle outer groove portion is formed on the door glass side of a connecting portion between the bottom wall and the vehicle outer side wall, a vehicle inner groove portion is formed on the door glass side of a connecting portion between the bottom wall and the vehicle inner side wall, and a thickness of the vehicle inner groove portion is greater than a thickness of the vehicle outer groove portion.

In the first aspect of the present invention, since the hard portion having a hardness higher than that of the vehicle outer side wall is formed inside the vehicle outer side wall or to be exposed on a vehicle inner side wall thereof, a vehicle outer groove portion is formed on a door glass side of a connecting portion between the bottom wall and the vehicle outer side wall, a vehicle inner groove portion is formed on a door glass side of a connecting portion between the bottom wall and the vehicle inner side wall, and the thickness of the vehicle inner groove portion is formed to be greater than the thickness of the vehicle outer groove portion, it is difficult to bend the vehicle inner groove portion between the vehicle inner side wall and the bottom wall when the glass run is attached to the door frame. As a result, when the vehicle inner groove portion is bent, the thick vehicle inner groove portion generates a force for pushing the bottom wall in the direction of the vehicle outer side wall. Therefore, the vehicle outer side wall is pressed in the direction of the door frame, and the vehicle outer side surface of the vehicle outer side wall, in particular, the vehicle outer side surface on the bottom wall side of the vehicle outer side wall can be reliably brought into contact with the door frame. As a result, the effect of reducing the vibration by utilizing impedance matching can be sufficiently exhibited.

On the other hand, since the thickness of the vehicle outer groove portion is smaller than the thickness of the vehicle inner groove portion, the vehicle outer side wall and the vehicle inner groove portion of the bottom wall are easily bent. As a result, attachment of the glass run to the door frame is not adversely affected.

The thickness of the vehicle inner groove portion and the thickness of the vehicle outer groove portion in the first aspect refer to the thinnest portions of the vehicle inner groove portion and the vehicle outer groove portion before the glass run is attached, that is, in a state where the vehicle outer side wall and the vehicle inner side wall are opened with respect to the bottom wall.

A second aspect of the present invention is the glass run according to the first aspect, in which the vehicle outer side wall and the door frame are in surface contact with each other, and the door glass is in contact with the vehicle outer side wall in a region where the hard portion is formed.

In the second aspect of the present invention, since the vehicle outer side wall and the door frame are in surface contact with each other, and the door glass comes into contact with the vehicle outer side wall in the region where the hard portion is formed, the rigidity of the vehicle outer side wall inserted between the door frame and the door glass increases, and the effect of reducing vibration using impedance matching can be increased.

Here, the “rigidity of the vehicle outer side wall” is represented by the amount of increase in reaction force from the vehicle outer side wall with respect to the change amount at the pressed portion when the vehicle outer side wall is pressed by the door glass or the door frame.

Therefore, the “rigidity of the vehicle outer side wall” refers to an increase in the slope (gradient) in the relationship between displacement and reaction force.

A third aspect of the present invention is the glass run according to the first aspect, in which the door frame includes a door frame groove portion and the basic structure is attached to the door frame groove portion, a vehicle outer holding lip extending toward a direction of a tip end portion of the vehicle outer side wall is formed in a vicinity of a vehicle outer side of a connecting portion between the vehicle outer side wall and the bottom wall, and a thin-walled portion that is thinned is formed at a base portion of the vehicle outer holding lip of the vehicle outer side wall.

The vehicle outer side holding lip extending toward a direction of the tip end portion of the vehicle outer side wall is elastically in contact with the door frame groove portion in the vicinity of the vehicle outer side of the connecting portion of the vehicle outer side wall with the bottom wall. The glass run has a function of preventing the glass run from coming out of the door frame groove portion after the attachment.

Meanwhile, when the thickness of the vehicle inner groove portion is formed to be greater than the thickness of the vehicle outer groove portion and the vehicle inner groove portion is attached to the door frame groove portion, a force for pushing the bottom wall toward a direction of the vehicle outer side wall is generated by the thick vehicle inner groove portion, whereas, on the other hand, a force for pushing back the above force toward a vehicle inner side is generated in the vehicle outer holding lip.

In the third aspect of the present invention, since the door frame includes the door frame groove portion, the basic structure is attached to the door frame groove portion, the vehicle outer holding lip that extends toward a direction of a tip end portion of the vehicle outer side wall is formed in a vicinity of the vehicle outer side of the connecting portion between the vehicle outer side wall and the bottom wall, the thin-walled portion that is thinned is formed at a base portion of the vehicle outer holding lip of the vehicle outer side wall, and the vehicle outer holding lip comes into contact with the door frame groove portion when the glass run is attached to the door frame, it is possible to suppress the generation of a force by the vehicle outer holding lip for pushing back a force for pushing the bottom wall toward a direction of the vehicle outer side wall by the thick vehicle inner groove portion by the collapse of a gap portion formed between the door frame groove portion, the thin-walled portion of the vehicle outer side wall, and the vehicle outer holding lip. As a result, since the vehicle outer side surface on the bottom wall side of the vehicle outer side wall can be reliably brought into contact with the door frame groove portion, the effect of reducing vibration using impedance matching can be sufficiently exhibited. Further, the glass run can be prevented from coming out of the door frame groove portion by the vehicle outside holding lip.

A fourth aspect of the present invention is the glass run according to the third aspect in which a stepped portion in which a wall thickness of the vehicle outer side wall becomes greater is formed toward a direction of a tip end portion of the vehicle outer side wall, and a vehicle outer tip end portion of the door frame groove portion and the stepped portion are not in contact with each other and a tip end side gap portion is formed between the vehicle outer tip end portion and the stepped portion.

In the case of holding the door frame groove portion bent and formed to be sandwiched between the two facing vehicle outer holding lips, for example, in a case where the length between the facing vehicle outer holding lips is shorter than the length of the sandwiched door frame groove portion due to dimensional tolerance, a force in a direction of separating the vehicle outer side wall from the door frame groove portion may be generated.

In the fourth aspect of the present invention, the stepped portion in which the wall thickness of the vehicle outer side wall becomes greater is formed toward a direction of a tip end portion of the vehicle outer side wall, the vehicle outer tip end portion of the door frame groove portion and the stepped portion do not come into contact with each other, and the tip end side gap portion is formed between the vehicle outer tip end portion and the stepped portion, and since the stepped portion in which the wall thickness of the vehicle outer side wall becomes greater is formed toward a direction of a tip end portion of the vehicle outer side wall, the vehicle outer tip end portion of the door frame groove portion and the stepped portion do not come into contact with each other, and the tip end side gap portion is formed between the vehicle outer tip end portion and the stepped portion, it is possible to eliminate a source of a force in a direction in which the vehicle outer side wall is separated from the door frame groove portion. As a result, since the vehicle outer side surface on the bottom wall side of the vehicle outer side wall can be reliably brought into contact with the door frame groove portion, the effect of reducing vibration using impedance matching can be sufficiently exhibited. In addition, since the vehicle outer side wall comes into contact with the door frame groove portion, it is not necessary to form the vehicle outer holding lip on the tip end portion side of the vehicle outer side wall, and the glass run can be reduced in weight.

A fifth aspect of the present invention is the glass run according to the first aspect, in which a vehicle outer holding lip extending toward a direction of a tip end portion of a vehicle outer side wall is formed in a vicinity of a vehicle outer side of a connecting portion with a bottom wall of the vehicle outer side wall, a vehicle outer side seal lip extending on a vehicle inner side and on a bottom wall side on the vehicle inner side of a tip end portion direction from the vehicle outer holding lip is formed on the vehicle outer side wall, in the vehicle outer side wall, a hard portion having a hardness higher than that of the vehicle outer side wall is formed inside the vehicle outer side wall or is formed to be exposed on a vehicle inner side of the vehicle outer side wall, the vehicle outer seal lip is in surface contact with the door glass at least when the door glass is closed, when the hard portion is formed inside the vehicle outer side wall, it is in surface contact with the vehicle outer side wall, and when the hard portion is formed to be exposed on a vehicle inner side of the vehicle outer side wall, it is in surface contact with the hard portion.

In the fifth aspect of the present invention, since the vehicle outer holding lip extending toward a direction of a tip end portion of a vehicle outer side wall is formed in a vicinity of a vehicle outer side of a connecting portion with a bottom wall of the vehicle outer side wall, the vehicle outer seal lip extending on a vehicle inner side and on a bottom wall side on the vehicle inner side of a tip end portion direction from the vehicle outer holding lip is formed on the vehicle outer side wall, in the vehicle outer side wall, the hard portion having a hardness higher than that of the vehicle outer side wall is formed inside the vehicle outer side wall or is formed to be exposed on a vehicle inner side of the vehicle outer side wall, the vehicle outer seal lip is in surface contact with the door glass at least when the door glass is closed, when the hard portion is formed inside the vehicle outer side wall, it is in surface contact with the vehicle outer side wall, and when the hard portion is formed to be exposed on a vehicle inner side of the vehicle outer side wall, it is in surface contact with the hard portion, the vehicle outer side wall in which the hard portion is formed is in surface contact with the vehicle outer seal lip, and the vehicle outer seal lip is in surface contact with the door glass, whereby the rigidity on the vehicle outer side of the glass run is improved. As a result, the effect of reducing the vibration by utilizing impedance matching can be sufficiently exhibited.

A sixth aspect of the present invention is the glass run according to the fifth aspect, in which a door frame side contact surface that is in surface contact with the door frame when attached to the door frame is formed on the bottom wall.

In the sixth aspect of the present invention, since the door frame side contact surface that is in surface contact with the door frame when attached to the door frame is formed on the bottom wall, it is possible to firmly fix the glass run to the door frame.

A seventh aspect of the present invention is the glass run according to the fifth aspect, in which the hard portion is formed by being divided into a vehicle inner side and a vehicle outer side of the vehicle outer side wall, and the vehicle outer hard portion formed on the vehicle outer side is exposed to the vehicle outer side of the vehicle outer side wall or formed penetrating from the vehicle inner side to the vehicle outer side.

In the seventh aspect of the present invention, since the hard portion is formed by being divided into a vehicle inner side and a vehicle outer side of the vehicle outer side wall, and the vehicle outer hard portion formed on the vehicle outer side is exposed on the vehicle outer side of the vehicle outer side wall or formed to penetrate from the vehicle inner side to the vehicle outer side, the rigidity of the vehicle outer side wall with respect to the door glass and the door frame is further increased, vibration energy is attenuated more efficiently, and noise caused by wind noise can be further reduced. As a result, the effect of reducing the vibration by utilizing impedance matching can be sufficiently exhibited.

### BRIEF DESCRIPTION OF THE DRAWINGS

FIG. 1 is a front view of an automobile door;

FIG. 2 is a front view illustrating a glass run used for a door frame of FIG. 1;

FIG. 3 illustrates a glass run according to a first embodiment of the present invention and is a cross-sectional view taken along line B-B of FIG. 2;

FIG. 4 is a cross-sectional view taken along line A-A of FIG. 1 according to the first embodiment of the present invention;

FIG. 5 illustrates a glass run of a second embodiment of the present invention, and is a cross-sectional view taken along line D-D of FIG. 2;

FIG. 6 is a cross-sectional view taken along line C-C of FIG. 1 according to the second embodiment of the present invention; and

FIG. 7 is a cross-sectional view illustrating an attachment structure of a conventional glass run (Japanese Patent Application Laid-Open No. 2023-53894).

### DETAILED DESCRIPTION OF PREFERRED EMBODIMENTS

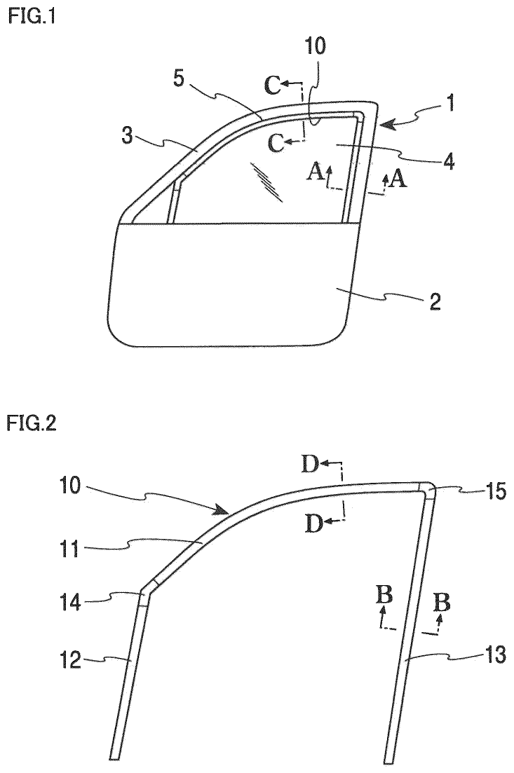

A first embodiment of the present invention will be described with reference to FIGS. 1 to 4. FIG. 1 is a front view of a left front door 1 of an automobile as viewed from a vehicle outer side. A door frame 3 is mounted on an upper portion of a door main body 2 that constitutes the front door 1. A window opening is formed by the door frame 3 and an upper edge of the door main body 2. A glass run 10 is attached to a door frame groove portion 5 formed in the door frame 3 and to an inside of the door main body 2 to guide raising and lowering of a door glass 4. It should be noted that the present invention is applicable not only to the left front door 1, but also to a right front door and right and left rear doors. Further, it can also be applied to a sliding door in which the door glass raises and lowers. FIGS. 1 and 2 are also used for the second embodiment of the present invention described later.

FIG. 2 is a simplified front view of only the glass run 10 as viewed from the vehicle outer side. The glass run 10 is composed of a first extrusion portion 11 corresponding to a horizontal frame portion of the door frame 3, a second extrusion portion 12 corresponding to a front vertical frame portion of the front door 1, and a third extrusion portion 13 corresponding to a rear vertical frame portion. The front end portion of the first extrusion portion 11 is connected to an upper end portion of the second extrusion portion 12 by a first molded portion 14. Further, the rear end portion of the first extrusion portion 11 is connected to an upper end portion of the third extrusion portion 13 by a second molded portion 15.

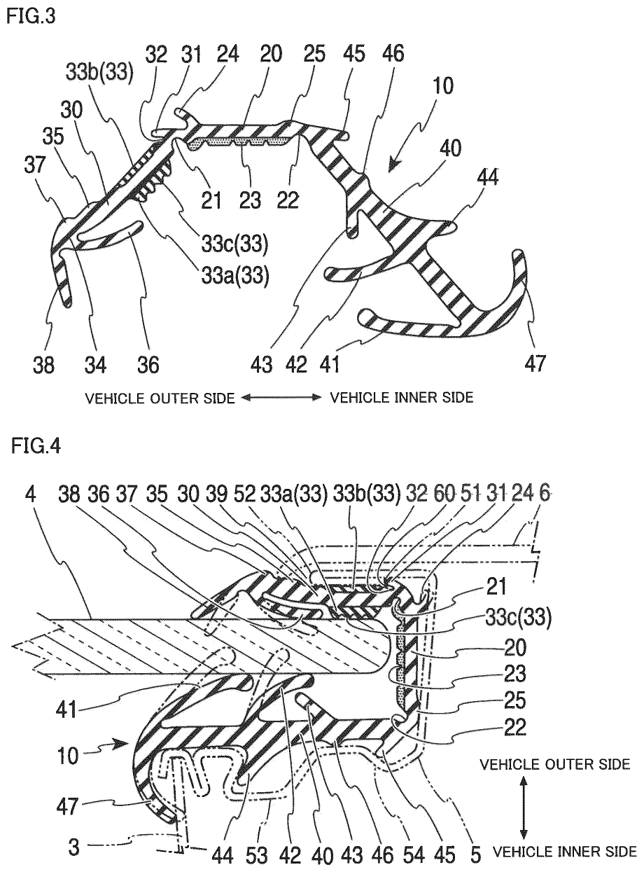

FIG. 3 is a cross-sectional view taken along line B-B in FIG. 2, and is a cross-sectional view of the third extrusion portion 13 corresponding to the longitudinal frame portion on the rear side of the door frame 3 before being attached to the door frame groove portion 5 of the door frame 3. The glass run 10 includes a bottom wall 20, a vehicle outer side wall 30, and a vehicle inner side wall 40 as its basic structure. Further, the vehicle inner side wall 40 is formed larger than the vehicle outer side wall 30, and its shape is asymmetrical with the vehicle inner side being larger.

At a connecting portion between the bottom wall 20 and the vehicle outer side wall 30, a vehicle outer groove portion 21 is formed, and at a connecting portion between the bottom wall 20 and the vehicle inner side wall 40, a vehicle inner groove portion 22 is formed, and the bottom wall is connected to be capable of being deployed by the vehicle outer groove portion 21 and the vehicle inner groove portion 22. Here, the vehicle inner groove portion 22 is formed thicker than the vehicle outer groove portion 21. Further, in order to make the vehicle inner groove portion 22 thicker, a projecting portion 25 protruding from the bottom wall 20 is formed on a side opposite to the vehicle inner groove portion 22. The projecting portion 25 may be omitted as long as the thickness of the vehicle inner groove portion 22 is ensured.

The bottom wall 20 is formed in a substantially plate shape, and on an inner surface (the door glass 4 side) of the bottom wall 20, a plurality of concave portions 23 of the bottom wall are continuously and parallelly formed in a longitudinal direction. Further, on an outer surface of the bottom wall 20, a bottom wall seal lip 24 is formed.

On the vehicle outer side of the vehicle outer side wall 30, a vehicle outer holding lip 31 extending toward a direction of the tip end portion of the vehicle outer side wall 30 is formed in the vicinity of the connecting portion with the bottom wall 20. Further, at a base portion of the vehicle outer holding lip 31 of the vehicle outer side wall 30, a thin-walled portion 32 that is thinned is formed.

A hard portion 33 having a hardness higher than that of a material constituting the vehicle outer side wall 30 is formed on the vehicle inner side of the vehicle outer side wall 30. Further, the hard portion 33 is divided into a vehicle inner hard portion 33a formed on the vehicle inner side of the vehicle outer side wall 30, and a vehicle outer hard portion 33b formed on the vehicle outer side and is formed. The vehicle inner hard portion 33a projects from the vehicle outer side wall 30 toward the vehicle inner side and is formed. On the other hand, the vehicle outer hard portion 33b, which is formed on the vehicle outer side, is located inside the vehicle outer side wall 30 and is formed to be exposed on the vehicle outer side of the vehicle outer side wall 30. Further, the vehicle outer hard portion 33b is formed at a position facing the vehicle inner hard portion 33a.

On the vehicle inner surface of the vehicle inner hard portion 33a, a plurality of convex ribs 33c are continuously and parallelly formed in the longitudinal direction.

Further, the vehicle outer hard portion 33b is not formed in the thin-walled portion 32. The vehicle outer hard portion 33b is formed in a direction toward a tip end portion 34 of the vehicle outer side wall 30 from the thin-walled portion 32.

In the present embodiment, the value X obtained by dividing the thickness of the hard portion 33 excluding the rib 33c (the sum of the thickness of the vehicle inner hard portion 33a and the thickness of the vehicle outer hard portion 33b) by the sum of the thickness of the hard portion 33 excluding the rib 33c and the thickness of the vehicle outer side wall 30 is 0.6. It is preferable that the value of X be 0.4 or more.

In the vehicle outer side wall 30, a stepped portion 35 having an increased wall thickness is formed in a direction toward the tip end portion 34 from the vehicle outer hard portion 33b.

The vehicle outer seal lip 36 is formed from the tip end portion 34 of the vehicle outer side wall 30 in the direction toward the vehicle inner side and the bottom wall 20 side. Further, a holding rib 37 is formed on the vehicle outer side of the tip end portion 34 of the vehicle outer side wall 30. Further, on the tip end side from the base portion of the vehicle outer seal lip 36 of the vehicle outer side wall 30, a vehicle outer cover lip 38 is formed in the direction toward the vehicle inner side and in the direction opposite to the bottom wall 20.

On the vehicle outer side of the vehicle inner side wall 40, a first vehicle inner seal lip 41 is formed to extend from the tip end portion of the vehicle inner side wall 40 toward the vehicle outer side and the bottom wall 20 side. Further, between the first vehicle inner seal lip 41 and the bottom wall 20, and extending toward the bottom wall 20 side, a second vehicle inner seal lip 42 is formed. Further, on the vehicle outer side surface of the vehicle inner side wall 40, on the bottom wall 20 side of the second vehicle inner seal lip 42, a sub-lip 43 is formed to extend toward the vehicle outer side and in the direction opposite to the bottom wall 20. The sub-lip 43 may be formed to extend toward the bottom wall 20 side. Furthermore, the sub-lip 43 may not be formed.

Further, on the vehicle inner side of the vehicle inner side wall 40, the second vehicle inner holding lip 45 that extends toward a direction of the tip end portion of the vehicle inner side wall 40 is formed in a vicinity of the connecting portion with the bottom wall 20, and the first vehicle inner holding lip 44 that extends toward a direction of the tip end portion of the vehicle inner side wall 40 is formed from a position between the second vehicle inner holding lip 45 and the tip end portion of the vehicle inner side wall 40. Further, between the first vehicle inner holding lip 44 and the second vehicle inner holding lip 45, a contact rib 46 is formed.

From the tip end portion of the vehicle inner side wall 40, a vehicle inner cover lip 47 is formed to extend toward the vehicle inner side and toward the bottom wall 20 side.

In the present embodiment, the hard portion 33 was made of polypropylene (PP), and the glass run 10 excluding the hard portion 33 was produced by extrusion molding using an olefin-based thermoplastic elastomer (TPO) having an International Rubber Hardness (IRHD) of 80±5. The hard portion 33 may be made of the same TPO as the other portions, and in this case, it is preferable that the IRHD be 100±5. Further, a hard resin material other than PP, for example, an olefin-based resin such as polystyrene, may be used.

FIG. 4 is a cross-sectional view taken along line A-A of FIG. 1. That is, it is a cross-sectional view when the glass run 10 of FIG. 3 is attached to the door frame groove portion 5 of the door frame 3 and the door glass 4 is closed. In FIG. 4, a center pillar 6 is attached on the vehicle outer side of the door frame groove portion 5. The door frame groove portion 5 is made of metal.

When the glass run 10 is attached to the door frame groove portion 5 of the door frame 3, the bottom wall seal lip 24 of the bottom wall 20 elastically contacts the door frame groove portion 5, and the projecting portion 25 comes into contact with the door frame groove portion.

On the vehicle outer side wall 30, the vehicle outer holding lip 31 comes into contact with a hemming-processed tip end portion 51 of the door frame groove portion 5 that has been subjected to hemming processing, and the vehicle outer hard portion 33b in in surface contact with the vehicle inner side of the door frame groove portion 5 that has been subjected to hemming processing. Further, a gap 60 is formed between the vehicle outer side wall 30 on the bottom wall 20 side of the vehicle outer hard portion 33b, a thin-walled portion 32, and the vehicle outer holding lip 31.

Further, the stepped portion 35 does not contact the bent portion of the hemming processing, that is, a vehicle outer tip end portion 52 of the door frame groove portion 5, and a tip end side gap portion 39 is formed between the stepped portion 35 and the vehicle outer tip end portion 52 of the door frame groove portion 5. Further, the tip end portion of the center pillar 6 comes into contact with the holding rib 37.

On the vehicle outer side of the vehicle inner side wall 40, the vehicle inner side wall 40 and the contact rib 46 come into contact with the door frame groove portion 5, and the first vehicle inner holding lip 44 and the second vehicle inner holding lip 45 come into contact with a first curved portion 53 and a second curved portion 54 of the door frame groove portion 5. Further, the vehicle inner cover lip 47 is elastically in contact with the door frame 3.

In FIG. 4, the vehicle outer groove portion 21 is deformed such that the vehicle inner side of the vehicle outer side wall 30 approaches the bottom wall 20 very closely, while in the vehicle inner groove portion 22, the vehicle outer side of the vehicle inner side wall 40 and the bottom wall 20 are deformed not to approach each other as closely toward the vehicle outer side, and is attached to the door frame groove portion 5.

When the door glass 4 is inserted between the vehicle outer side wall 30 and the vehicle inner side wall 40, on the vehicle outer side, the vehicle outer cover lip 38 deforms toward the side opposite to the bottom wall 20, and the vehicle outer seal lip 36 deforms toward the bottom wall 20 side, and elastically contacts the vehicle outer side of the door glass 4. Further, the vehicle outer side of the door glass 4 comes into contact with the rib 33c formed on the vehicle inner hard portion 33a of the hard portion 33.

On the other hand, on the vehicle inner side, the first vehicle inner seal lip 41 and the second vehicle inner seal lip 42 both deform toward the bottom wall 20 side, and elastically contact the vehicle inner side of the door glass 4.

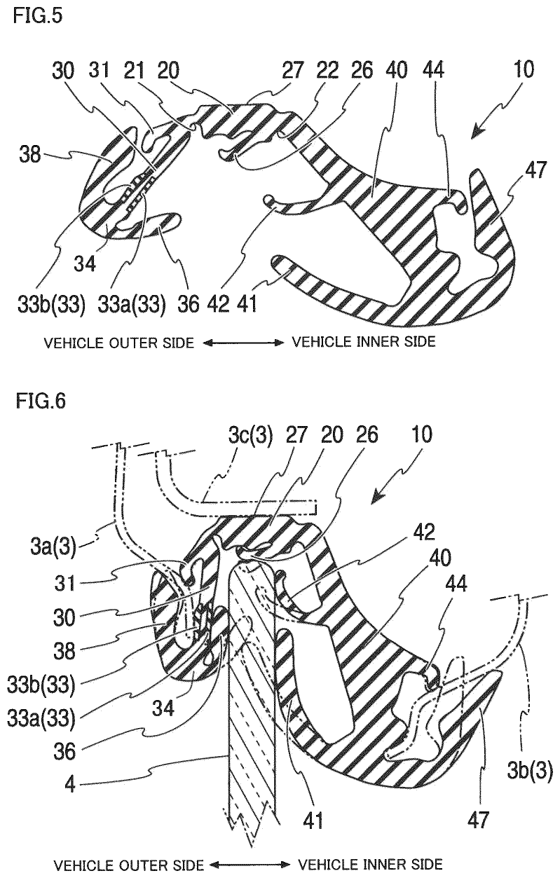

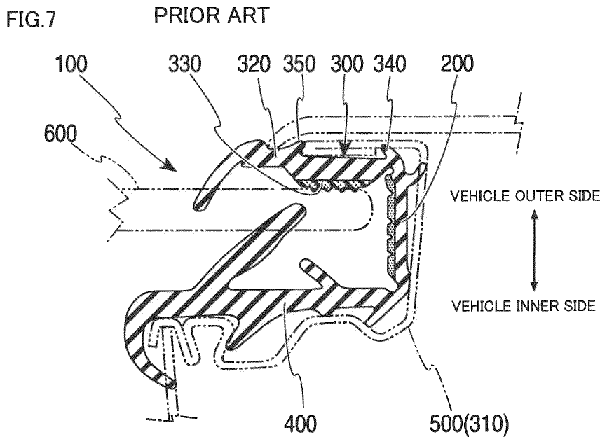

Next, the second embodiment of the present invention will be described with reference to FIGS. 1, 2, 5, and 6. FIG. 5 is a cross-sectional view taken along line D-D in FIG. 2, and is a cross-sectional view of the first extrusion portion 11 corresponding to the longitudinal frame portion of the door frame 3 before being attached to the door frame groove portion 5 of the door frame 3. Further, FIG. 6 is a cross-sectional view taken along line C-C in FIG. 1, and is a cross-sectional view when the glass run 10 of FIG. 5 is attached to the door frame 3 and the door glass 4 is closed.

The present second embodiment is different from the first embodiment in the following points in addition to the difference in the attachment portion.

The door frame 3 does not include the door frame groove portion 5, and the door frame 3 includes an outer frame 3a, an inner frame 3b, and an upper frame 3c.

In the glass run 10, the bottom wall 20 does not include a bottom wall seal lip 24 and includes a door glass side seal lip 26 the door glass 4 side, and includes a door frame side contact surface 27 which is a flat portion on the side opposite to the door glass 4 side.

Further, the vehicle outer side wall 30 does not include the rib 33c in the hard portion 33, the region coming into contact with the outer frame 3a bulges to the vehicle outer side, the vehicle outer seal lip 36 can come into contact with the vehicle inner hard portion 33a, and the vehicle outer cover lip 38 extends in the vehicle outer direction and toward the bottom wall 20. Further, the vicinity of the connecting portion of the vehicle outer seal lip 36 with the vehicle outer side wall 30 is formed to be thinner than the tip end portion.

The reason why the region of the vehicle outer side wall 30 in contact with the outer frame 3a bulges outward from the vehicle is to increase the connection strength with the outer frame 3a.

Further, the reason why the vicinity of the connecting portion of the vehicle outer seal lip 36 with the vehicle outer side wall 30 is formed to be thinner than the tip end portion is that the vehicle outer seal lip 36 is easily deformed toward the vehicle outer side wall 30 side when coming into contact with on the door glass 4.

Further, the vehicle inner side wall 40 does not include a sub lip 43 and include the second vehicle inner holding lip 45 and the contact rib 46, and the region where the first vehicle inner holding lip 44 is formed is formed thick on the vehicle inner side.

The reason why the region where the first vehicle inner holding lip 44 is formed to be thick on the vehicle inner side is that the vehicle inner side wall 40 is longer than the vehicle outer side wall 30, and thus deflection is suppressed when the glass run is attached to the door frame 3 and when the door glass 4 comes into contact with it.

When the glass run 10 is attached to the door frame 3, the outer frame 3a is inserted between the vehicle outer cover lip 38 and the vehicle outer side wall 30 on the vehicle outer side, and the vehicle outer holding lip 31 elastically contacts the outer frame 3a. Further, the vehicle outer hard portion 33b and the outer frame 3a are in surface contact with each other.

On the other hand, on the vehicle inner side, the inner frame 3b is inserted between the vehicle inner cover lip 47 and the vehicle inner side wall 40, and the first vehicle inner holding lip 44 elastically contacts the inner frame 3b.

Further, on the bottom wall 20, the door frame side contact surface 27 is in surface contact with the upper frame 3c.

When the door glass 4 is inserted between the vehicle outer side wall 30 and the vehicle inner side wall 40, the vehicle outer seal lip 36 comes into contact with the vehicle outer side of the door glass 4 on the vehicle outer side, and is deformed toward the vehicle outer side wall 30 side. On the other hand, on the vehicle inner side, the first vehicle inner seal lip 41 and the second vehicle inner seal lip 42 come into contact with the vehicle inner side of the door glass 4 and are deformed toward the vehicle inner side wall 40 side.

As illustrated in FIG. 6, when the door glass 4 is closed, on the bottom wall 20 side, the door glass side seal lip 26 falls down to the bottom wall 20 side and is in contact with the bottom wall 20 and the door glass 4.

Further, on the vehicle outer side wall 30 side, the vehicle outer seal lip 36 comes into contact with the vehicle outer hard portion 33b, is sandwiched between the door glass 4 and the vehicle outer side wall 30, and is pressed toward the vehicle outer side.

As described in detail above, according to the present embodiments, the following effects can be obtained.

(1) In the first embodiment described above, since the thickness of the vehicle inner groove portion 22 is formed to be greater than the thickness of the vehicle outer groove portion 21, it is difficult to bend the vehicle inner groove portion 22 between the vehicle inner side wall 40 and the bottom wall 20 when the glass run 10 is attached to follow the shape of the door frame groove portion 5 formed in the door frame 3. As a result, when the vehicle inner groove portion 22 is bent, a force for pushing the bottom wall 20 toward the vehicle outer side wall 30 direction is generated by the thick vehicle inner groove portion 22. Therefore, the vehicle outer side wall 30 is pressed in a direction toward the door frame groove portion 5, so that the vehicle outer side surface of the vehicle outer side wall 30, particularly the vehicle outer side surface on the bottom wall 20 side of the vehicle outer side wall 30, can be reliably brought into contact with the door frame groove portion 5. As a result, the effect of reducing the vibration by utilizing impedance matching can be sufficiently exhibited.

On the other hand, since the thickness of the vehicle outer groove portion 21 is smaller than the thickness of the vehicle inner groove portion 22, the vehicle outer groove portion 21 of the vehicle outer side wall 30 and the bottom wall 20 can be easily bent and easily follow the shape of the door frame groove portion 5. As a result, attachment of the glass run 10 to the door frame groove portion 5 is not adversely affected.

(2) Since the vehicle outer holding lip 31 is formed to extend toward a direction of the tip end portion 34 of the vehicle outer side wall 30 in the vicinity of the vehicle outer side of the connecting portion between the vehicle outer side wall 30 and the bottom wall 20, and the thin-walled portion 32 that is thinned is formed at the base portion of the vehicle outer holding lip 31 of the vehicle outer side wall 30, it is possible to suppress the generation of a force that pushes back a force for pushing the bottom wall 20 toward a direction of the vehicle outer side wall 30 by the thick vehicle inner groove portion 22 by the collapse of the gap portion 60 formed between the door frame groove portion 5, the thin-walled portion 32 of the vehicle outer side wall 30, and the vehicle outer holding lip 31. As a result, since the vehicle outer side surface on the bottom wall 20 side of the vehicle outer side wall 30 can be reliably brought into contact with the door frame groove portion 5, the effect of reducing vibration using impedance matching can be sufficiently exhibited. Further, the glass run 10 can be prevented from coming out of the door frame groove portion 5 by the vehicle outer holding lip 31.

(3) Since the stepped portion 35 in which a wall thickness of the vehicle outer side wall 30 becomes greater in a direction toward the tip end portion 34 of the vehicle outer side wall 30 is formed, the vehicle outer tip end portion 52 of the door frame groove portion 5 and the stepped portion 35 of the vehicle outer side wall 30 are not in contact with each other, and the tip end side gap portion 39 is formed between the vehicle outer tip end portion 52 of the door frame groove portion 5 and the stepped portion 35 of the vehicle outer side wall 30, it is possible to eliminate a source of a force in a direction in which the vehicle outer side wall 30 is separated from the door frame groove portion 5 by being sandwiched by the two facing vehicle outer holding lips. As a result, since the vehicle outer side surface of the vehicle outer side wall 30 can be reliably brought into contact with the door frame groove portion 5, the effect of reducing vibration using impedance matching can be sufficiently exhibited. Further, since the vehicle outer side wall 30 comes into contact with the door frame groove portion 5, it is not necessary to form the vehicle outer holding lip on the tip end portion 34 side of the vehicle outer side wall 30, and the glass run 10 can be reduced in weight.

(4) Since a plurality of convex ribs 33c are continuously and parallelly formed in a longitudinal direction on a vehicle inner surface of the vehicle inner hard portion 33a, it is possible to prevent dust, dirt, or foreign matter from being caught in the vehicle inner hard portion 33a when the door glass 4 raises and lowers, thereby preventing the occurrence of abnormal noise associated therewith.

(5) Since, in the above second embodiment, the vehicle outer holding lip 31 extending in a direction toward the tip end portion 34 of the vehicle outer side wall 30 is formed in a vicinity of the vehicle outer side of the connecting portion between the bottom wall 20 and the vehicle outer side wall 30, and on a vehicle inner side of the tip end portion 34 of the vehicle outer side wall 30, the vehicle outer seal lip 36 extending toward a vehicle inner side and toward the bottom wall 20 side is formed, and in the vehicle outer side wall 30, the hard portion 33 having a hardness higher than that of the vehicle outer side wall 30 is divided into a vehicle outer side and a vehicle inner side so that the vehicle outer hard portion 33b is formed to be exposed on the vehicle inner side, the vehicle outer seal lip 36 is in surface contact with the door glass 4 and also in surface contact with the vehicle outer hard portion 33b when the door glass 4 is closed, the rigidity on the vehicle outer side of the glass run 10 is improved. As a result, the effect of reducing the vibration by utilizing impedance matching can be sufficiently exhibited.

(6) Further, since the door frame side contact surface 27 that is in surface contact with the upper door frame 3c when attached to the door frame 3 is formed on the bottom wall 20, it is possible to firmly fix the glass run 10 to the upper frame 3c.

(7) Since, in the above first and second embodiments, the hard portion 33 is formed by being divided into the vehicle inner hard portion 33a formed on a vehicle inner side of the vehicle outer side wall 30 and the vehicle outer hard portion 33b formed on a vehicle outer side thereof, and the vehicle outer hard portion 33b is formed at a position facing the vehicle inner hard portion 33a and is formed to be exposed on the vehicle outer side of the vehicle outer side wall 30, and the vehicle outer hard portion 33b is in surface contact with the door frame groove portion 5 in the first embodiment and with the outer frame 3a in the second embodiment, rigidity of the vehicle outer side wall 30 with respect to the door glass 4 and the door frame 3 is further increased, vibration energy is more efficiently attenuated, and noise due to wind noise can be further reduced. As a result, the effect of reducing the vibration by utilizing impedance matching can be sufficiently exhibited.

The embodiment of the present invention is not limited to the above embodiment, and various modifications can be made without departing from the object of the present invention.

For example, in the above embodiment, the hard portion 33 is formed by being divided into the vehicle inner hard portion 33a formed on a vehicle inner side of the vehicle outer side wall 30 and the vehicle outer hard portion 33b formed on a vehicle outer side thereof; however, the hard portion 33 may be formed without being divided, and only the vehicle inner hard portion 33a may be formed.

For example, in the above first embodiment, the vehicle outer hard portion 33b is formed inside the vehicle outer side wall 30 and so as to be exposed on a vehicle outer side of the vehicle outer side wall 30; however, similarly to the vehicle inner hard portion 33a, the vehicle outer hard portion 33b may be formed so as to protrude from the vehicle outer side wall 30.

For example, in the above first embodiment, although all of the features described in the above effects, that is,
(1) the thickness of the vehicle inner groove portion 22 being formed to be greater than the thickness of the vehicle outer groove portion 21,
(2) the formation of the vehicle outer holding lip 31 in a vicinity of a vehicle outer side of a connecting portion between the bottom wall 20 and the vehicle outer side wall 30 and the thin-walled portion 32 that is thinned at a base portion of the vehicle outer holding lip 31,
(3) the formation of the stepped portion 35 in which a wall thickness of the vehicle outer side wall 30 increases in the tip end portion 34 direction of the vehicle outer side wall 30, the vehicle outer tip end portion 52 of the door frame groove portion 5 and the stepped portion 35 of the vehicle outer side wall 30 being not in contact with each other, and the tip end side gap portion 39 being formed therebetween the vehicle outer tip end portion 52 of the door frame groove portion 5 and the stepped portion 35 of the vehicle outer side wall 30, and
(4) the hard portion 33 being formed by being divided into a vehicle inner hard portion 33a formed on a vehicle inner side of the vehicle outer side wall 30 and a vehicle outer hard portion 33b formed on a vehicle outer side thereof,
are included, in order to improve the followability of the vehicle outer side wall 30 having the hard portion 33 with high hardness to the curved door frame 3 (including the door frame groove portion 5) and to sufficiently exhibit the vibration-reducing effect utilizing impedance matching, the feature (1) is essential, whereas the other features (2) to (4) can be selectively applied.

1. A glass run having a bottom wall, a vehicle outer side wall, and a vehicle inner side wall as a basic structure, the basic structure being attached to a door frame and guiding raising and lowering of a door glass, wherein,
in the vehicle outer side wall, a hard portion having a hardness higher than that of the vehicle outer side wall is formed inside the vehicle outer side wall or exposed on a vehicle inner side thereof,
a vehicle outer groove portion is formed on the door glass side of a connecting portion between the bottom wall and the vehicle outer side wall,
a vehicle inner groove portion is formed on the door glass side of a connecting portion between the bottom wall and the vehicle inner side wall,
a thickness of the vehicle inner groove portion is greater than a thickness of the vehicle outer groove portion, and
a vehicle outer cover lip extends in the vehicle outer direction and toward the bottom wall.

2. (canceled)

3. (canceled)

4. (canceled)

5. A glass run having a bottom wall, a vehicle outer side wall, and a vehicle inner side wall as a basic structure, the basic structure being attached to a door frame and guiding raising and lowering of a door glass, wherein,
in the vehicle outer side wall, a hard portion having a hardness higher than that of the vehicle outer side wall is formed inside the vehicle outer side wall or exposed on a vehicle inner side thereof,
a vehicle outer groove portion is formed on the door glass side of a connecting portion between the bottom wall and the vehicle outer side wall,
a vehicle inner groove portion is formed on the door glass side of a connecting portion between the bottom wall and the vehicle inner side wall,
a thickness of the vehicle inner groove portion is greater than a thickness of the vehicle outer groove portion, and
a vehicle outer seal lip that extends toward a vehicle inner side and toward the bottom wall side is formed on a vehicle inner side of the vehicle outer side wall,
the vehicle outer seal lip is in surface contact with the door glass at least when the door glass is closed, and
when the hard portion is formed inside the vehicle outer side wall, the vehicle outer seal lip is in surface contact with the vehicle outer side wall, whereas when the hard portion is formed to be exposed on the vehicle inner side of the vehicle outer side wall, the vehicle outer seal lip is in surface contact with the hard portion.

6. The glass run according to claim 5, wherein a door frame side contact surface that is in surface contact with the door frame when attached to the door frame is formed on the bottom wall.

7. The glass run according to claim 5, wherein the hard portion is formed by being divided into a vehicle inner side and a vehicle outer side of the vehicle outer side wall, and the vehicle outer hard portion formed on the vehicle outer side is exposed to the vehicle outer side of the vehicle outer side wall or formed penetrating from the vehicle inner side to the vehicle outer side.

8. The glass run according to claim 5, wherein
the door frame includes an outer frame, and
the vehicle outer side wall includes the region coming into contact with the outer frame that bulges to the vehicle outer side.

9. A glass run having a bottom wall, a vehicle outer side wall, and a vehicle inner side wall as a basic structure, the basic structure being attached to a door frame and guiding raising and lowering of a door glass, wherein,
in the vehicle outer side wall, a hard portion having a hardness higher than that of the vehicle outer side wall is formed inside the vehicle outer side wall or exposed on a vehicle inner side thereof,
a vehicle outer groove portion is formed on the door glass side of a connecting portion between the bottom wall and the vehicle outer side wall,
a vehicle inner groove portion is formed on the door glass side of a connecting portion between the bottom wall and the vehicle inner side wall,
a thickness of the vehicle inner groove portion is greater than a thickness of the vehicle outer groove portion,
in the vehicle inner side wall, a vehicle inner holding lip is formed, and
the region where the vehicle inner holding lip is formed is formed thick on the vehicle inner side.
